(19) United States
(12) Patent Application Publication
(10) Pub. No.: US 2024/0284032 A1
(43) Pub. Date: Aug. 22, 2024

(54) Processing Method for Conference System, and Control Apparatus for Conference System

(71) Applicant: Yamaha Corporation, Hamamatsu-shi (JP)

(72) Inventor: Ryo TANAKA, Hamamatsu-shi (JP)

(21) Appl. No.: 18/652,187

(22) Filed: May 1, 2024

Related U.S. Application Data
(63) Continuation of application No. PCT/JP2022/040590, filed on Oct. 31, 2022.

(30) Foreign Application Priority Data
Nov. 2, 2021 (JP) 2021-179167

(51) Int. Cl. H04N 23/611; G06V 10/94; G06V 40/16; H04N 23/62

(52) U.S. Cl. CPC H04N 23/611; G06V 10/945; G06V 40/161; H04N 23/62

(57) ABSTRACT

A processing method for a conference system is a processing method for a conference system including a controller including an operation element, a camera, and a processing controller. The camera obtains image data. The processing controller detects an object included in the image data, receives a selection operation to the detected object through the operation element of the controller, and performs image processing on the image data or control of the camera, with respect to the selected object.

### CROSS-REFERENCE TO RELATED APPLICATIONS

This application is a continuation of PCT Application No. PCT/JP2022/040590, filed on Oct. 31, 2022, which claims priority to Japanese Application No. 2021-179167, filed on Nov. 2, 2021. The contents of these applications are incorporated herein by reference in their entirety.

### TECHNICAL FIELD

An embodiment of the present disclosure relates to a processing method for a conference system and a control apparatus for the conference system.

### BACKGROUND

Patent Literature 1 discloses a configuration in which an image recognition means to recognize image data from a camera is used to specify one talker among a plurality of talkers and move the camera automatically in a direction of the specific talker.

Patent Literature 2 discloses a configuration in which a talker microphone detector 31 detects a microphone (whether a microphone to which a talker is currently talking is a microphone a, a microphone b, or a microphone c) receiving the highest volume and zooms in and captures a talker with a TV camera 35.

Patent Literature 3 discloses a configuration in which display is performed relative to a size and position of a selected human face according to a certain scale factor.

Patent Literature 4 discloses that a position of a specified imaging object is detected, a position of a microphone that is present in an imaging screen imaged by a camera is detected, and adjustment of an imaging range of the camera is controlled so that the position of a microphone may be positioned in a preset region in the imaging screen.

### CITATION LIST

### Patent Literature

Patent Literature 1: Japanese Unexamined Patent Application Publication No. H9-322136
Patent Literature 2: Japanese Unexamined Patent Application Publication No. H6-105306
Patent Literature 3: Japanese Unexamined Patent Application Publication No. H9-247641
Patent Literature 4: National Publication of International Patent Application No. 2018-517984

### SUMMARY

The automatic processing disclosed in Patent Literatures 1, 2, and 4 may have a case in which a person at whom a user is not gazing is selected and an image that reflects no intention of the user is outputted. Patent Literature 3 selects manually, so that a user oneself has to search and select a target object from an image captured with a camera.

In view of the above circumstances, one aspect of the present disclosure is directed to provide a processing method for a conference system that is able to output an image that reflects an intention of a user even when an object is automatically detected.

A processing method for a conference system according to an embodiment of the present disclosure is a processing method for a conference system including a controller including an operation element, a camera, and a processing controller. The camera obtains image data. The processing controller detects an object included in the image data, receives a selection operation to the detected object through the operation element of the controller, and performs image processing on the image data or control of the camera, with respect to the selected object.

According to an embodiment of the present disclosure, an image that reflects an intention of a user is able to be outputted even when an object is automatically detected.

### BRIEF DESCRIPTION OF DRAWINGS

FIG. 1 is a block diagram showing a configuration of a conference system 1 and a terminal 15.

FIG. 2 is a block diagram showing a configuration of a PC 11.

FIG. 3 is a block diagram showing a configuration of a controller 17.

FIG. 4 is a schematic outer view of an operation element 172.

FIG. 5 is a block diagram showing a functional configuration of the terminal 15.

FIG. 6 is a flowchart showing an operation of the terminal 15.

FIG. 7 is a view showing an example of an image captured by a camera 154.

FIG. 8 is a view showing an example of an image captured by the camera 154.

FIG. 9 is a view showing an example of an image after image processing.

FIG. 10 is a view showing an example of a case of superimposing image data P2 on image data P1.

FIG. 11 is a view showing an example of a case of receiving a selection of two objects.

FIG. 12 is a view showing an example of an image after image processing.

FIG. 13 is a block diagram showing a functional configuration of a terminal 15 according to a modification.

### DETAILED DESCRIPTION

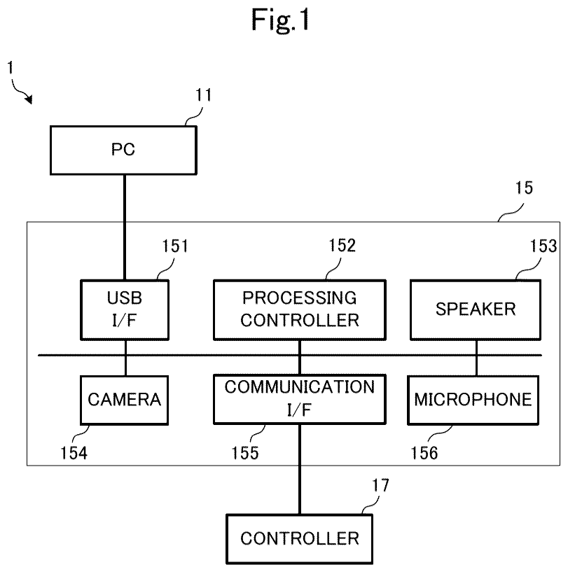

FIG. 1 is a block diagram showing a configuration of a conference system 1 and a configuration of a terminal 15. The conference system 1 includes a PC 11, a terminal 15, and a controller 17. The conference system 1 is a system for holding a Web conference by connecting to an information processing apparatus such as a PC at a remote place. The terminal 15 is an example of a control apparatus for the conference system according to the present disclosure.

The terminal 15 includes a USB interface (I/F) 151, a processing controller 152, a speaker 153, a camera 154, a communication I/F 155, and a microphone 156. The terminal 15 is connected to the PC 11 through the USB I/F 151. The terminal 15 is connected to the controller 17 through the communication I/F 155.

The processing controller 152 is configured by a microcomputer, for example, and collectively controls an operation of the terminal 15. The terminal 15 obtains a voice of a user of the conference system 1 through the microphone 156. The terminal 15 sends an audio signal according to an obtained voice, to the PC 11, through the USB I/F 151. The terminal 15 obtains an image through the camera 154. The terminal 15 sends the image data according to an obtained image, to the PC 11, through the USB I/F 151. In addition, the terminal 15 receives the audio signal from the PC 11 through the USB I/F 151 and emits a sound through the speaker 153.

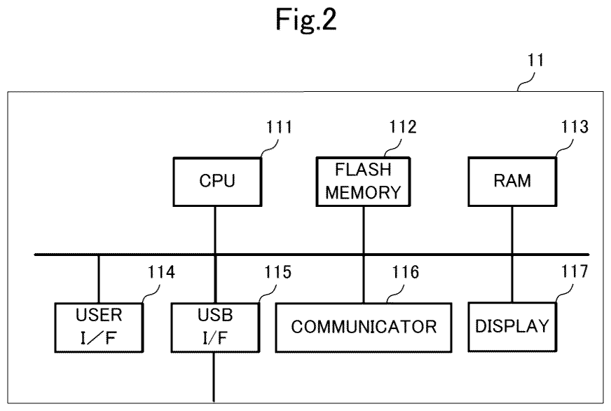

The PC 11 is a general personal computer. FIG. 2 is a block diagram showing a configuration of the PC 11. The PC 11 includes a CPU 111, a flash memory 112, a RAM 113, a user I/F 114, a USB I/F 115, a communicator 116, and a display 117.

The CPU 111, by reading a program for a Web conference from the flash memory 112 to the RAM 113, connects to a PC at a remote place or the like and holds a Web conference. The user I/F 114 includes a mouse and a keyboard, and receives an operation of a user. The user instructs to start the program for a Web conference, for example, through the user I/F 114.

The USB I/F 115 is connected to the terminal 15. The PC 11 receives the audio signal and the image data from the terminal 15 through the USB I/F 115. The PC 11 sends the received audio signal and image data to the PC at a remote place or the like, through the communicator 116. The communicator 116 is a network interface of a wireless LAN or a wired LAN, and is connected to the PC at a remote place. The PC 11 receives the audio signal and image data from the PC at a remote place or the like, through the communicator 116. The PC 11 sends the received audio signal to the terminal 15 through the USB I/F 115. In addition, the PC 11 displays a video according to a Web conference on the display 117, based on the image data received from the PC at a remote place or the like and the image data received from the terminal 15. It is to be noted that connection between the PC 11 and the terminal 15 is not limited to connection through the USB. The PC 11 and the terminal 15 may be connected by another communicator such as an HDMI (registered trademark), a LAN, or Bluetooth (registered trademark).

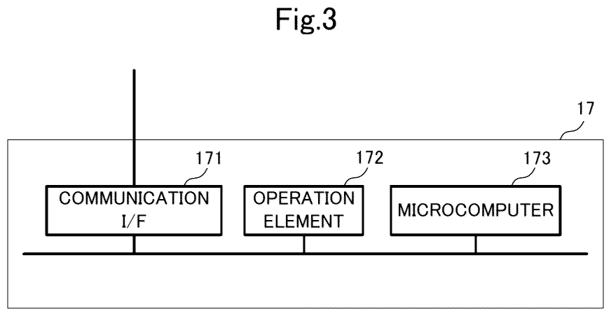

The controller 17 is a remote controller for operating the terminal 15. FIG. 3 is a block diagram showing a configuration of the controller 17. The controller 17 includes a communication I/F 171, an operation element 172, and a microcomputer 173. The communication I/F 171 is a communicator such as a USB or Bluetooth (registered trademark). The microcomputer 173 collectively controls operations of the controller 17. The controller 17 receives an operation of a user through an operation element 172. The controller 17 sends an operation signal according to the received operation, to the terminal 15 through the communication I/F 171.

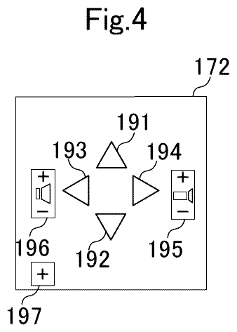

FIG. 4 is a schematic outer view of the operation element 172. The operation element 172 has a plurality of touch-panel type keys as an example. The operation element 172 of FIG. 4 has direction keys 191, 192, 193, and 194, a zoom key 195, a volume key 196, and a mode switching key 197. As a matter of course, the operation element 172 is not limited to a touch panel but may be a physical key switch.

The direction keys 191, 192, 193, and 194 are keys for changing a capture direction of the camera 154. The direction key 191 indicating an up direction and the direction key 192 indicating a down direction corresponds to tilting. The direction key 193 indicating a left direction and the direction key 194 indicating a right direction corresponds to panning. The zoom key 195 has a “+” key for zoom-in, and a “−” key for zoom-out, and changes a capture range of the camera 154. The volume key 196 is a key for changing a volume of the speaker 153.

It is to be noted that a change in the capture direction and a change in the capture range may be performed by changing image processing on the image data obtained by the camera 154 or may be performed by mechanically and optically controlling the camera 154.

The mode switching key 197 is an operation element to switch a manual framing mode by the direction keys 191, 192, 193, and 194 and the zoom key 195, and an automatic framing mode. The terminal 15, when being specified as being in the automatic framing mode through the mode switching key 197, executes a processing method shown in the present embodiment.

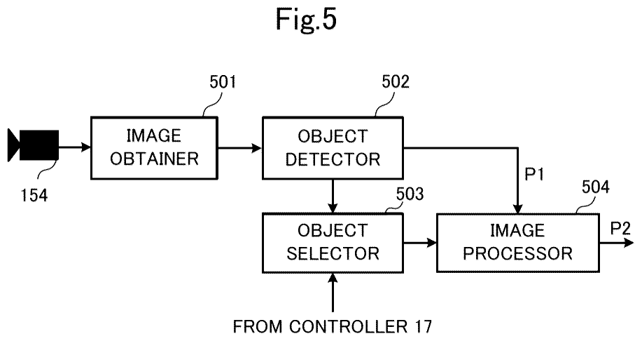

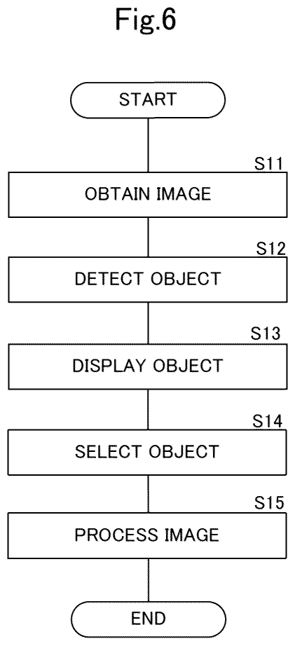

FIG. 5 is a block diagram showing a functional configuration of the terminal 15 (the processing controller 152) in the automatic framing mode. FIG. 6 is a flowchart showing an operation of the terminal 15 (the processing controller 152) in the automatic framing mode.

The processing controller 152 of the terminal 15 functionally includes an image obtainer 501, an object detector 502, an object selector 503, and an image processor 504. The image obtainer 501 obtains image data from the camera 154 (S11). The object detector 502 detects an object from the obtained image data (S12).

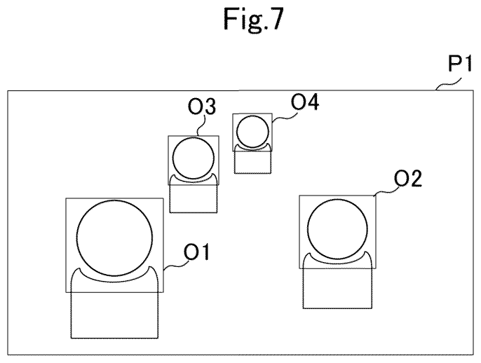

FIG. 7 is a view showing an example of an image captured by the camera 154. In this example, the object is a person. The object detector 502 identifies a person by performing face recognition processing, for example. The face recognition processing is processing to recognize a face position by using a predetermined algorithm such as a neural network or the like, for example.

In the example of FIG. 7, the object detector 502 detects four persons (O1 to O4). The object detector 502 adds label information such as O1 to O4 to each of the detected persons, and outputs position information (X and Y coordinates of a pixel) of each person to the image processor 504. The image processor 504 displays the object by receiving image data P1 and displaying a boundary box (Bounding Box) as shown by the square in FIG. 7 in the received image data P1 (S13). The boundary box is set in a range including the positions of the face and shoulder of a person. It is to be noted that, in this example, the object detector 502 adds the label information in ascending order according to the size of an object.

Then, the object selector 503 receives a selection operation of an object through the operation element 172 of the controller 17 (S14). In the automatic framing mode, the direction key 193 and the direction key 194 that are shown in FIG. 4 function as an operation element for receiving the selection operation of an object. For example, the object selector 503, when first receiving the operation of the direction key 193 or the direction key 194, selects an object (the object O1 in FIG. 7) of the smallest numbered object. The object selector 503, when next receiving the operation of the direction key 194, selects an object (the object O2 in FIG. 7) of the second smallest numbered object. The object selector 503, each time receiving the operation of the direction key 194, changes a selection in turn to an object of the larger numbered object. The object selector 503, each time receiving the operation of the direction key 193, changes a selection in turn to an object of the smaller numbered object. In such a manner, the user can change the object to select by the operation of the direction keys 193 and 194.

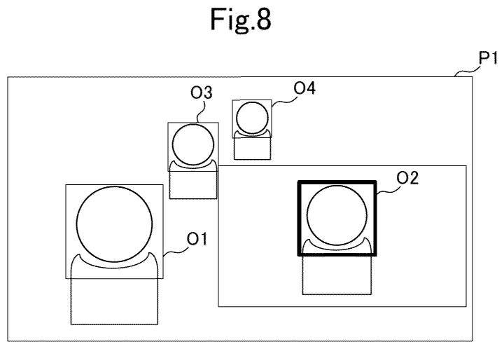

It is to be noted that the image processor 504, by highlighting the selected object, may indicate that the object has been selected. For example, the image processor 504, when the object O2 is selected, as shown in FIG. 8, highlights the selected object by increasing a line width of the boundary box of the object O2 or changing a color.

It is to be noted that the object detector 502 may calculate the reliability of detection results of the face recognition processing, or the like. The object selector 503 may cause an object of which the calculated reliability is below a predetermined value not to be selected.

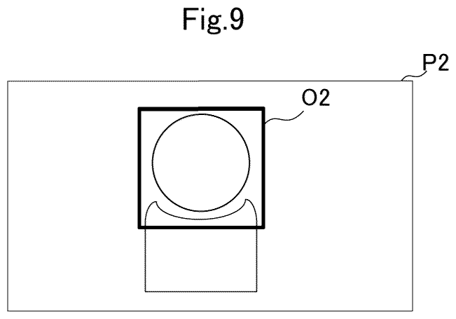

Then, the image processor 504 performs image processing on the image data P1, with respect to the selected object (S15). The image processing includes framing by panning, tilting, or zooming, for example. As an example, the image processor 504, as shown in FIG. 8 and FIG. 9, performs panning and tilting so that the selected object O2 may be positioned in the center of a screen. Then, the image processor 504 performs zooming so that the occupancy in the screen of the selected object O2 may be a predetermined ratio (50%, for example). Accordingly, image data P2 to be outputted by the image processor 504 displays the selected object O2 in the center of the screen at the predetermined ratio. In other words, the image processor 504 outputs the image data P2 that displays the object O2 selected by the user in the center of the screen at the predetermined ratio.

The processing controller 152 sends the image data P2 that the image processor 504 has outputted, to the PC 11. The PC 11 sends the received image data to the PC of a remote place. The processing controller 152, as described above, performs image processing with respect to the object O2 selected by the user, in the automatic framing mode. Accordingly, even when the object O2 hypothetically moves, for example, the processing controller 152 outputs image data that always displays the object O2 in the center of the screen at the predetermined ratio.

In such a manner, the processing method for the conference system according to the present embodiment automatically detects a plurality of objects by the face recognition processing or the like and further performs image processing, with respect to the object selected by the user, among the plurality of objects. The processing method for the conference system according to the present embodiment, even when detecting a person at whom the user is not gazing as an object, outputs the image data that displays the object selected by the user in the center at the predetermined ratio, so that the person at whom the user is gazing may be centered and the image that reflects the intention of the user is outputted. On the other hand, since the plurality of objects as candidates of selection are detected automatically, the user does not need to manually look for the object as a candidate of selection.

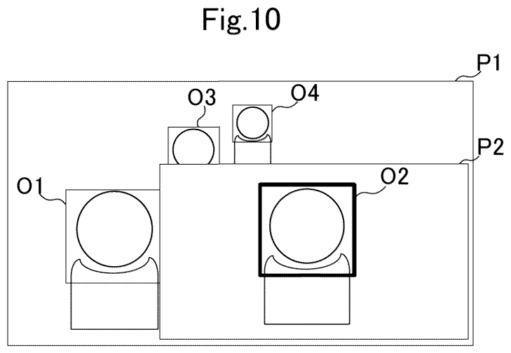

It is to be noted that the image processor 504 may superimpose the framed image data P2 on the obtained image data P1 and output the data. For example, FIG. 10 is a view showing an example of a case of superimposing the image data P2 on the image data P1. In the example of FIG. 10, the image processor 504 enlarges the image data P2 to be superimposed on the lower right of the image data P1. As a matter of course, the position at which the image data P2 is superimposed is not limited to the lower right but may be the lower left, the center, or the like. As a result, the processing method for the conference system according to the present embodiment is also able to display the image that reflects the intention of the user while displaying the entire image captured by the camera 154.

In addition, the object to be selected is not limited to a single object. In the automatic framing mode, the direction key 191 and the direction key 192 among the operation elements 172 shown in FIG. 4 function as operation elements for designating the number of objects to be selected. For example, the object selector 503, when receiving an operation of the direction key 191, receives a selection of two objects. The object selector 503, when further receiving an operation of the direction key 191, receives a selection of three objects. The object selector 503, each time receiving the operation of the direction key 191, increases the number of selections of objects to be received. The object selector 503, each time receiving the operation of the direction key 192, decreases the number of selections of objects to be received.

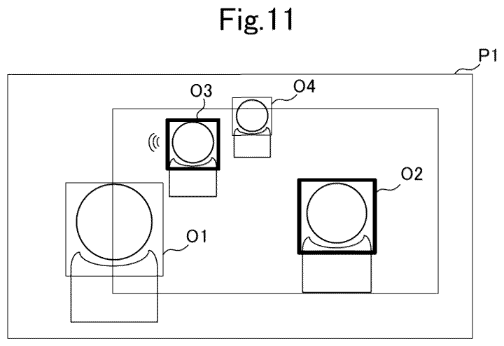

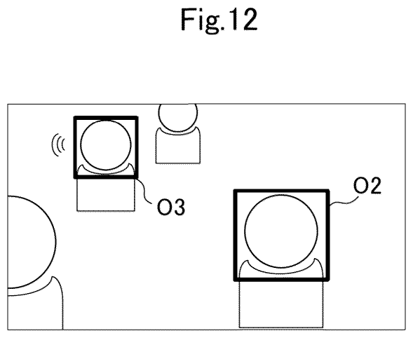

FIG. 11 is a view showing an example of a case of receiving the selection of two objects. In the example of FIG. 11, the number of selected objects is two and the object O2 and the object O3 are selected. The image processor 504 performs image processing on the image data P1 with respect to the selected object O2 and object O3. As an example, the image processor 504, as shown in FIG. 12, performs panning, tilting, and zooming so that the selected object O2 and object O3 may be within a frame. Accordingly, the image data P2 to be outputted by the image processor 504 displays the selected object O2 and object O3.

It is to be noted that the image processor 504 may generate image data obtained by framing the object O2 and image data obtained by framing the object O3, and superimpose each image data on the image data P1 obtained by the camera 154 and output the image data.

The above example shows an example in which the processing controller 152 performs image processing with respect to an object selected by the image processor 504. However, the processing controller 152 may control the camera 154 with respect to the selected object. In this case as well, the processing controller 152 performs framing by panning, tilting, or zooming, for example. For example, as shown in FIG. 8 and FIG. 9, the camera 154 is controlled to perform panning and tilting so that the selected object O2 may be positioned in the center of a screen. Then, the processing controller 152 controls the camera 154 to perform zooming so that the occupancy in the screen of the selected object O2 may be a predetermined ratio (50%, for example).

In addition, in the above example, the processing controller 152 sends the image data on which the image processing or camera control has been performed, to the PC on a reception side at a remote place. However, the processing controller 152 may detect an object from the image data received from the PC of a remote place and perform image processing with respect to the selected object. The processing controller 152 displays the image data on which the image processing has been performed, on the PC 11 and displays on the display 117. As a result, the processing controller 152, for the image data to receive as well, is able to select any object from automatically detected objects and also generate image data with respect to the selected object.

In addition, the processing controller 152 may simply output information indicating a position of the selected object and the image data obtained by the camera 154. In such a case, the PC of the remote place that receives image data performs image processing with respect to the object, based on the information indicating the position of an object.

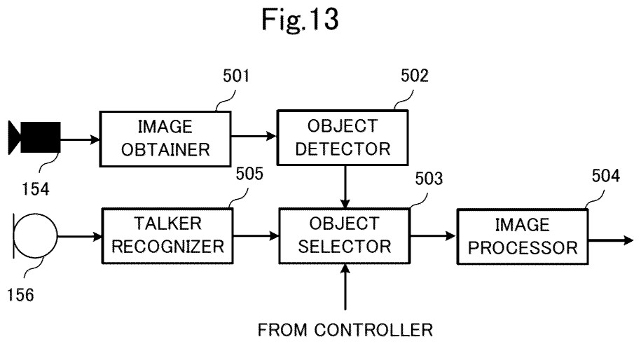

Next, FIG. 13 is a block diagram showing a functional configuration of a terminal 15 according to a modification. The terminal 15 according to the modification further includes a talker recognizer 505. Other functional configurations are the same as the functional configurations of the example shown in FIG. 5.

The talker recognizer 505 obtains an audio signal from the microphone 156. The talker recognizer 505 recognizes a talker from the obtained audio signal. For example, the microphone 156 has a plurality of microphones. The talker recognizer 505 determines a timing at which a voice of the talker has reached the microphone by determining the cross correlation of audio signals obtained by a plurality of microphones. The talker recognizer 505 is able to determine an arrival direction of the voice of the talker, based on a positional relationship of each of the plurality of microphones and an arrival timing of the voice. In addition, the talker recognizer 505 is also able to determine a distance from the talker by determining the arrival timing of the voice of the talker by use of three or more microphones.

The talker recognizer 505 outputs information indicating the arrival direction of the voice of the talker, to the object selector 503. The object selector 503 further selects an object corresponding to a recognized talker, based on the arrival direction of the voice of the talker and the information on the distance. For example, in the example of FIG. 11, the object O3 emits a voice. The talker recognizer 505 compares the arrival direction of the voice of a talker and the information on the distance to the position of the object detected by the image data. The talker recognizer 505 causes the size of the boundary box of the object to associate with the distance. For example, the processing controller 152 stores a table in which the size of the boundary box is associated with the distance in advance. The talker recognizer 505 selects the object of a talker at the nearest position from the relationship of the direction of each object among the image data P1, and the distance. In the example of FIG. 11, a talker in a direction of about 10° to the left from the front and at a distance of 3 m, for example, is detected. In such a case, the talker recognizer 505 selects the object O3.

Accordingly, the object selector 503, in addition to the object selected by the user, recognizes a talker from the audio signal obtained by the microphone 156 and further selects the recognized talker as an object. In such a case, the image processor 504 performs image processing to a talker who is currently talking, in addition to the person at whom the user is gazing. For example, in the example of FIG. 11, in a case in which the user selects the object O2, when the person of the object O3 talks, the image data P2 that the image processor 504 outputs, as shown in FIG. 12, displays the object O2 selected by the user and the object O3 selected by talker recognition. Accordingly, the processing controller 152 is able to output image data including a talker who is currently talking, in addition to an object at which the user is gazing.

The description of the present embodiments is illustrative in all points and should not be construed to limit the present disclosure. The scope of the present disclosure is defined not by the foregoing embodiments but by the following claims. Further, the scope of the present disclosure includes the scopes of the claims and the scopes of equivalents.

For example, an object is not limited to a person. The object may be an animal, for example, or may be a white board or the like. The processing controller 152, for example, is able to enlarge a white board used for a conference for easier viewing.

The image processing and the camera control are not limited to panning, tilting, and zooming. For example, the terminal 15 may apply a focus on the selected object and perform image processing or camera control that removes the focus of other objects. In such a case, the terminal 15 is able to vividly capture only the object selected by the user and blur other objects.

In addition, the terminal 15 may perform adjustment of white balance or exposure control. In this case as well, the terminal 15 is able to vividly capture only the object selected by the user.

What is claimed is:

1. A processing method for a conference system, wherein the conference system comprises a controller including an operation element, a camera, a display, and a processing controller, the method comprising:
obtaining, by the processing controller, image data from the camera;
detecting, by the processing controller, an object included in the image data;
causing, by the processing controller, the detected object to be displayed on the display;
receiving, by the processing controller, a selection operation of the detected object through the operation element of the controller; and
performing, by the processing controller, image processing on the image data or control of the camera, with respect to the selected object.

2. The processing method according to claim 1, wherein the conference system further comprises a microphone, the method comprising:
obtaining, by the processing controller, an audio signal from the microphone; and
recognizing, by the processing controller, a talker from the audio signal and selects the recognized talker as the object.

3. The processing method according to claim 1, wherein
the image processing or the control of the camera includes panning, tilting, or zooming.

4. The processing method according to claim 1, comprising:
performing, by the processing controller, the image processing on the image data or the control of the camera so as to center the selected object.

5. The processing method according to claim 1, comprising:
receiving, by the processing controller, a change operation of a number of objects through the operation element of the controller; and
receiving, by the processing controller, the selection operation to the number of objects changed by the change operation.

6. The processing method according to claim 1, wherein
the image processing or the control of the camera includes focusing.

7. The processing method according to claim 1, wherein
the image processing or the control of the camera includes adjustment of white balance or exposure control.

8. The processing method according to claim 1, comprising:
sending, by the processing controller, the image data after the image processing or the camera control is performed, to an apparatus on a reception side.

9. The processing method according to claim 1, wherein
the image processing includes processing to extract the object from the image data to be superimposed on the image data.

10. The processing method according to claim 1, comprising:
causing, by the processing controller, a display that the object has been selected to be displayed on the display.

11. A control apparatus for a conference system comprising:
a controller including an operation element;
a camera;
a display; and
a processing controller configured to:
obtain image data from the camera;
detect an object included in the image data;
cause the detected object to be displayed on the display;
receive a selection operation of the detected object through the operation element of the controller; and
perform image processing on the image data or control of the camera, with respect to the selected object.

12. The control apparatus according to claim 11, comprising:
a microphone,
wherein the processing controller is configured to:
obtain an audio signal from the microphone; and
recognize a talker from the audio signal and select the recognized talker as the object.

13. The control apparatus according to claim 11, wherein
the image processing or the control of the camera includes panning, tilting, or zooming.

14. The control apparatus according to claim 11, wherein the processing controller is configured to:
perform the image processing on the image data or the control of the camera so as to center the selected object.

15. The control apparatus according to claim 11, wherein the processing controller is configured to:
receive a change operation of a number of objects through the operation element of the controller; and
receive the selection operation to the number of objects changed by the change operation.

16. The control apparatus according to claim 11, wherein
the image processing or the control of the camera includes focusing.

17. The control apparatus according to claim 11, wherein
the image processing or the control of the camera includes adjustment of white balance or exposure control.

18. The control apparatus according to claim 11, wherein the processing controller is configured to:
send the image data after the image processing or the camera control is performed to an apparatus on a reception side.

19. The control apparatus according to claim 11, wherein
the image processing includes processing to extract the object from the image data to be superimposed on the image data.

20. The control apparatus according to claim 11, wherein the processing controller is configured to:
cause a display that the object has been selected to be displayed on the display.
